(19) United States
(12) Patent Application Publication
(10) Pub. No.: US 2006/0168556 A1
(43) Pub. Date: Jul. 27, 2006

(54) Engineering system for distributed development and development by a number of users

(76) Inventors: Diamantis Gikas, Nurnberg (DE); Ronald Lange, Furth (DE); Ralf Leins, Ispringen (DE); Klaus Meusser, Furth (DE); Jurgen Schmoll, Markt Berolzheim (DE); Markus Weinlander, Happurg (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/314,841

(22) Filed: Dec. 21, 2005

(30) Foreign Application Priority Data
Dec. 21, 2004 (EP) 04030321.6

(51) Int. Cl. G06F 9/44

(52) U.S. Cl. 717/104

(57) ABSTRACT

A system and a method for processing of projects, especially engineering projects, in the automation environment, with the aid of which parts of project can be split off and processed independently of each other, with a seamless integration into the main project subsequently being undertaken without further adaptation effort is provided. In this way it is possible in the environment of larger projects to work in parallel on different subprojects and the subprojects can be further developed independently of each other.

### CROSS REFERENCE TO RELATED APPLICATIONS

This application claims priority of the European application No. 04030321.6 EP filed on Dec. 21, 2004, which is incorporated by reference herein in its entirety.

### FIELD OF INVENTION

The invention relates to a system and a method for processing of projects, especially engineering projects in the automation environment.

### BACKGROUND OF INVENTION

Nowadays engineering projects, especially in the automation environment, are generally subdivided into a number of subprojects. In such cases different corporate units or many different developers can be working on the subprojects under some circumstances. A distributed development or a distributed engineering project is therefore a widely-known scenario in today's automation environment. For this reason it is desirable if the opportunity is provided for enabling very large projects to be subdivided into smaller units for example, to increase the effectiveness of the individual units and thereby of the overall project. In this case the subdivided subprojects must be synchronized in respect of their developments running in parallel. After the end of the relevant subprojects the individual completed parts must be combined again.

Similarly a subproject is frequently handed over to a subcontractor for development within the development framework. A group of developers will accordingly implement parts of an automation solution, for example a machine, more or less independently of other developers. In this case too it is necessary to ensure that the corresponding subprojects are incorporated seamlessly into the overall project.

A further activity in which only subprojects of an overall solution are relevant, is to be seen in the local testing environment for example. Within the framework of his activities a developer makes changes to a subproject and the corresponding subproject itself is changed and tested in itself without the overall project being disturbed. In this case too, after activities have ended, the tested or modified subproject is merged back into the overall project.

A further requirement for today's development projects is the fact that parts of projects or projects are re-used. To this end parts of an existing project are extracted and included in new applications for example.

All these scenarios require a splitting-off of specific parts of a project and the facility for further processing of the split-off subprojects independently of each other. A seamless incorporation or an insertion into the main project after processing is at an end is necessary in these cases. Nowadays the synchronization of the subprojects to be developed in parallel is realized as a rule after consultation with the aid of fixed definitions of interfaces which may not be changed.

### SUMMARY OF INVENTION

An object of the present invention thus consists of specifying a system and a method with the aid of which parts of projects can be split off and processed independently of each other, with a seamless integration into the main project being able to be undertaken subsequently without further adaptation effort.

The object is achieved by a system for processing projects, especially engineering projects in the automation environment with a first exemplar of a project planning environment for processing a project, especially a main project, first means for creating (at least) one copy of objects from the project, at least one second exemplar of a project environment for processing at least one subproject, with subproject comprising the copy of the objects from the project and second means for re-inserting the objects processed in the subproject into the project.

The invention is based on the knowledge that larger projects can be subdivided into smaller part projects or subprojects by a function which takes over the division. Independently of each other the subprojects can subsequently be processed and subsequently, after the end of the processing, the subprojects are joined back together or combined using a further function. In this way in the environment of larger projects it is possible to work in parallel on different subprojects and the subprojects can be further developed independently of each other.

The subprojects are generated such that a subproject is separated from a main project by for example selecting different objects from the main project and copying them. These objects are then subsequently blocked for further processing in the main project. Objects not selected in the main project can however continued be processed. The copied objects which can subsequently be further processed in a subproject are fully capable of being processed after they have been copied. They can be modified accordingly.

In this case however relevant interfaces to objects which have remained in the main project cannot be modified within the framework of the subproject. Only such changes as lie within the subproject can be made. Everything that has consequences for other objects not present in the subproject and would result in a corresponding change to these objects may not be changed within the framework of the subproject.

In addition to the objects copied into the subproject other objects or information, for example libraries which are of relevance for development activities, are available within the framework of the subproject. These further objects or information can likewise not be changed within the framework of the subproject. They are set to “read only”.

After processing has been undertaken independently in the subproject or in a number of subprojects, the subprojects can be smoothly reintegrated into the original main project. This is made possible by a further function which is available within the framework of the project environment. The recombination occurs smoothly since the objects in the main project have not been changed, so that two different versions of the subproject are not present. In addition the interfaces of the objects of the subproject which are relevant as interfaces to the outside world can also not be changed to allow a seamless integration into the main project.

By splitting off and subsequent week recombination of different sizes of projects in different sizes the present invention allows a distributed project structure within the framework of large development projects. Furthermore it makes possible completely independent processing of individual subprojects or also execution of tests and the execution of corresponding changes after the tests have been performed independently of each other. With the aid of the present invention the engineering of large automation solutions is thus made significantly easier within the automation environment.

It is also advantageous that it is possible for the user to specify the size or choice of the subprojects within the framework of the project planning environment. The user has for example a list of all relevant objects and can specify in this list which objects are to be copied for one subproject and then are to be blocked for processing in the corresponding main project. This makes the splitting-off of subprojects by the corresponding developers freely scalable. Different selection criteria or can be created for the splitting-off of subprojects. For example subprojects can be selected on the basis of the project tree or also specific objects simply allocated to specific developers if the latter have special know-how within the context of the realization of an automation solution for these objects. Further criteria for the subdivision of a main project into different subprojects are conceivable.

If subsequent inclusion into the main project is not necessary or is not required, if for example only one existing subproject is provided for use within the context of another application or another project, it is also possible for the additional objects or information, for example a library of function modules which are transferred with the subproject, to be able to be processed as well. In this case it is not necessary to keep the interfaces to the objects of the main project static and to suppress a change. In this case the created copy which can be further processed within the context of the subproject is freely editable.

A further advantageous embodiment of the invention comprises enabling a processable subproject to be subdivided further. In this way, especially with the large projects, a tree structure type subdivision of a main project into subprojects can be undertaken at different hierarchy levels. The further subdivision of a subproject is realized in such a way that the objects copied out of the subproject are in their turn not editable in the subproject while they can be edited in the sub-subproject. This enables a cascade of editable units to be generated within the framework of an automation solution which makes parallel further development of the automation solution possible and simultaneously ensures a smooth integration of the individual work packets into one another.

Further advantageous embodiments of the invention are specified in the dependent claims.

### BRIEF DESCRIPTION OF THE DRAWINGS

The invention is described and explained in more detail below on the basis of the exemplary embodiments shown in the Figures.

The figures show:

FIG. 1 a schematic diagram of the system for processing different subprojects,

FIG. 2 an execution sequence in which a subcontractor processes a subproject,

FIG. 3 a schematic diagram of a scenario in which a subproject is re-used,

FIG. 4 a schematic diagram of the processing of a subproject within the framework of a large project,

FIG. 5 a scenario in which a subproject is tested locally.

### DETAILED DESCRIPTION OF INVENTION

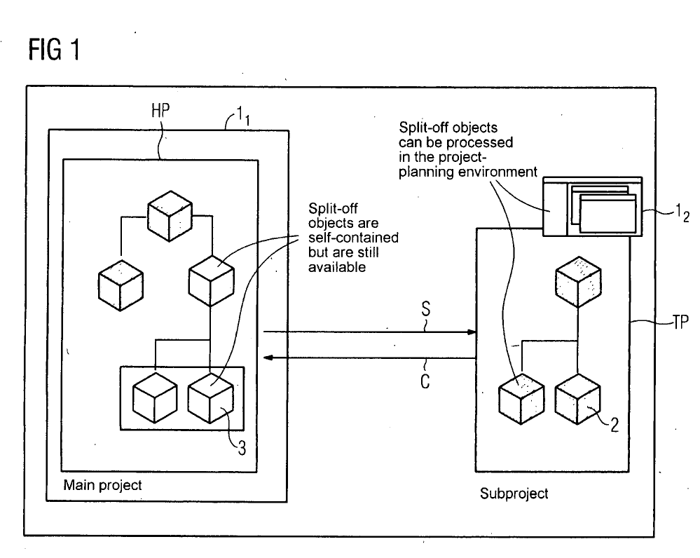

FIG. 1 shows a system for processing projects by splitting them up and subsequently combining them. Within the framework of the system a main project HP is processed in the first project environment 11. A subproject is generated by a function from the main project HP in this way. The function is realized in this case from the first means S (Split function) for creating a copy of objects 2. The objects 2 are processed in a subproject TP with a second exemplar of a project environment 12. In this case a number of exemplars of the project environment a number of subprojects can be processed independently of each other, even if this is only shown for one of subproject in FIG. 1.

In the main project HP the copied objects remain in the form of original objects 3. Although these subjects can be read within the framework of the main project they are quasi locked and thus not editable for developers working within the framework of the main project. There is a copy of the objects 2 in the subproject TP. These objects can be processed by the developers who are working within the framework of the subproject TP. After completion of the processing of the subproject TP a further function can be used to recombine of the subproject TP with the main project HP. To this end the system has available a second means C (Combine function) to reinsert the objects processed in the subproject TP into the main project.

A project can in this case for example be split off from the main project as follows: As part of the system there exists a function “File>Safe subproject”. Within the context of this function the user is offered a dialogue which provides a choice of the subproject which is to be sent out. In this case the user can for example chose the individual objects from which the main project H P is made up and thus select them for re-use within the framework of the subproject. The dialog also allows the user to specify a location for the storage of the subproject. After the user has selected the subproject or the objects to be split off by using the menu or the project navigator, he can use the Split function to create the corresponding subproject, which leads to the corresponding original object being blocked in the main project. Alternatively the blocking can also be overwritten by the user in the main project so that an almost parallel development of the two subprojects is possible.

As well as the objects 2 selected for the subproject, further objects can be copied into the split off subproject within the framework of the system. This is done for example if these objects are necessary or worthwhile for the engineering work. These further copied-out objects are however read-only objects They cannot be changed within the framework of the subproject.

A change to these additional objects copied into the subproject is only possible if this has been specified by the user in a corresponding dialog. This is worthwhile for example within the framework of a duplication of the subprojects and a re-use in another project in which the subproject is then not incorporated into the main project again. In this case all objects of the subproject can be changed accordingly. A subproject TP can also be subdivided within the framework of the inventive system into further subprojects. In this case the same opportunities of provided as those described for the first splitting off of a subproject.

Smooth combination of the edited subprojects into a main project is guaranteed by the fact that in the main project no modifications could be made to the corresponding objects 3. Furthermore the smooth recombination is guaranteed by the fact that in the subprojects likewise no modifications could be made to the interfaces relevant for the main project. This means that a seamless insertion of the subprojects into the main project and integration is possible.

The integration is performed in this case by the Combine function C. The Combine function combines the subprojects with each other again. This is a smooth operation if no underlying structure change has been made within the framework of the subprojects TP. It can however occur that within the framework of the subproject objects are renamed or have been inserted into other folders or also removed. The insertion of new objects within the framework of a subproject is also possible. If such changes are made within the framework of the processing of the subproject they are subsequently shown accordingly in the main project after recombination has taken place. For example the name of an object which was changed in the subproject is deleted in the main project where it still exists by the Combine function during the insertion and replaced by the new name. The procedure is similar for objects for which the position was changed. Deleted Objects are simply deleted in the main project whereas inserted objects are also reinserted at the corresponding position in the main project and represented.

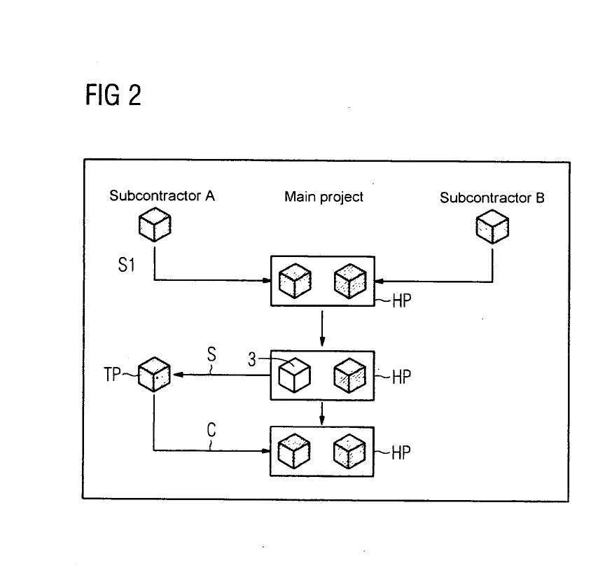

FIG. 2 shows the sequence of operations of a project in which subcontractors are developing subprojects independently of one another. In a first step S1 two or more projects are combined into a main project, in this case the Combine function C has to preserve the authors of an object or of a subproject. This makes it possible for the corresponding authors or subcontractors to split off their part from the main project again using the Split function S. This is necessary if for example changes are necessary to a machine which was supplied by a subcontractor. In the next step a subproject TP is split off from the main project using the Split function S. A copy 3 of the subproject remains in this case in the main project but the objects of this copy are blocked, so that no changes can be made. The subproject TP can for example be processed by subcontractor A. After processing is ended, the subproject TP can be recombined or integrated by the Combine function C back into the main project.

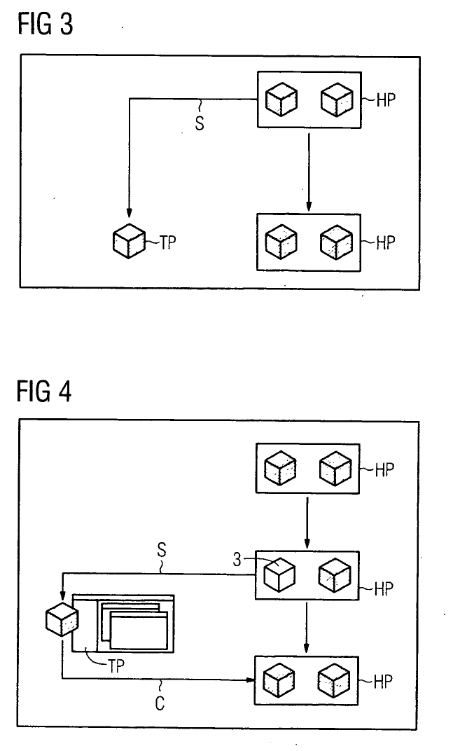

FIG. 3 shows a scenario which allows the re-use of automation solutions or parts thereof which have been already developed. The Split function S can be used to split off a subproject TP from the main project HP. If when the user of the system applies the Split function it is specified that the original objects remaining in the main project are not be blocked, these can continue to be changed in the main project. Likewise in the newly created subproject the information additionally copied into the subproject, for example libraries, are not blocked so that work can also be undertaken in the subproject. This almost achieves a doubling of the existing projects or solutions. The subproject can in this case then be used within the framework of another project. In the environment of this scenario it is not possible, through the Combine function subsequently to combine the subproject back into the main project if corresponding changes have been made in the main project, so that the two projects have developed differently and recombination would lead to conflicts.

FIG. 4 shows the scenario of a large project, in which the Split & Combine function is used in order to increase the effectiveness of the project overall. In this case a normal main project HP is processed. If the project becomes too large or access to a specific file server is no longer possible, or autonomous processing, for example on a mobile computer with a corresponding project planning environment is required. A user of the system can split off parts from a main project HP into a subproject TP and process this independently of the main project. In this case the subproject TP can also be processed again, whereas the objects 3 of the subproject TP which have remained as original objects in the main project HP are blocked. After processing by the Combine function C has been completed, this again allows the smooth integration of the processed subproject into the main project.

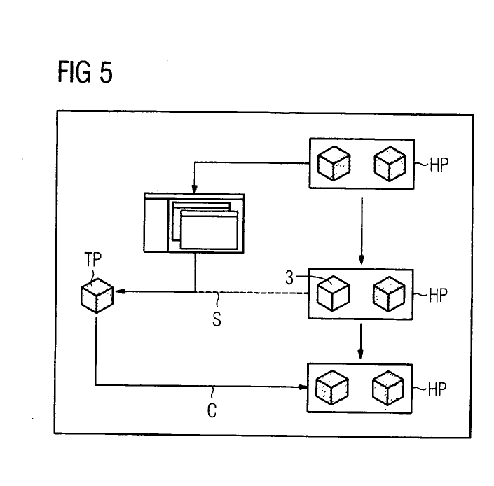

FIG. 5 presents a scenario which shows the local testing of a subproject. In this case local testing is supported by the Split & Combine function. A user for example starts working on a normal project. This involves opening and changing objects. Before the objects are returned to the main project HP and stored there, they can for example be split off from the main project with the aid of the Split function S. This can for example involve relatively small units which are to be split off. The split-off subproject or the object can be worked on independently of the main project. The split-off subproject can run through a test scenario independently of the main project and subsequently errors detected on the basis of the test can be rectified. Subsequently the tested and processed subproject can be integrated back with the Combine function C into the main project.

1.-16. (canceled)

17. A method for processing engineering projects in the automation environment, comprising:
processing in a first project environment a main project having a plurality of objects;
copying at least one of the plurality of objects from the main project to a subproject;
processing in a second project environment the subproject including at least one of the copied objects;
inserting the processed copied objects in the subproject into the main project;
blocking in the main project the processing of the copied objects until the copied object is inserted into the main project.

18. The method according to claim 17, further comprising providing a selection of the object available in the main project.

19. The method according to claim 18, further providing a list of the plurality of objects present in the main project wherein a user selects from the list the objects for copying.

20. The method according to claim 17, wherein an additional object is added to the copied object and/or information is added to the copied object.

21. The method according to claim 20, wherein the additional object is not released form processing in the subproject and/or information is not released for processing in the subproject.

22. The method according to claim 20, wherein the additional object is released for processing in the subproject and/or information is released for processing in the subproject.

23. The method according to claim 17, wherein an additional subproject is created from the subproject.

24. The system for processing engineering projects, comprising:
a first project planning environment for processing a first project;
a plurality of objects in the first project;
an object copier adapted to copy at least one of the plurality of objects;
a second project planning environment for processing a second project having the copied object; and
an object inserter adapted to insert the processed copied objects into the first project.

25. The system according to claim 24, further comprising:
an object blocker capable of blocking in the first project the copied object, and
an object unblocker capable of unblocking in the first project the copied object after the copied object is inserted in the first project from the second project.

26. The system according to claim 25, further comprising a list of the plurality of objects in the first project wherein a user determines from the list an object to be copied.

27. The system according to claim 26, wherein the list excludes the blocked copied object.

28. The system according to claim 25, wherein
a further object is copied from the first project into the second project or
information is copied from the first project into the second project or
a further object and information are copied from the first project into the second project.

29. The system according to claim 28, wherein the further object cannot be processed in the second project.

30. The system according to claim 28, wherein the further object is processed in the second project.

31. The system according to claim 28, wherein the information cannot be processed in the second project.

32. The system according to claim 28, wherein the information is processed in the second project.

33. The system according to claim 25, further comprising a third project planning environment for processing a third project wherein at least portion of the copied objects in the second project are further copied into the third project.
